(19) United States
(12) Patent Application Publication
(10) Pub. No.: US 2008/0198529 A1
(43) Pub. Date: Aug. 21, 2008

(54) Method For Operating A Solenoid Valve For Quantity Control

(76) Inventor: Helmut Rembold, Stuttgart (DE)

Correspondence Address: STRIKER, STRIKER & STENBY, 103 East Neck Road, Huntington, NY, 11743, US

(21) Appl. No.: 10/587,795

(22) PCT Filed: Mar. 14, 2005
(86) PCT No.: PCT/EP05/51147

§ 371 Date: Jul. 31, 2006

(30) Foreign Application Priority Data
Apr. 21, 2004 (DE) 10 2004 019 152.2

(51) Int. Cl. F02D 41/20; F02D 41/38; H01H 47/22; F01L 9/04; F16K 31/02; G05D 7/06

(52) U.S. Cl. 361/195; 251/129.15; 137/1; 700/282

(57) ABSTRACT

A method for controlling a solenoid valve, particularly in a motor vehicle. The inventive method is characterized by applying a first voltage (U_{—}1) to a coil (21) of the solenoid valve (22) until a first point in time (t_{—}1) and then applying a second voltage (U_{—}2) with a smaller value. The first point in time t_{—}1 precedes the point in time at which the solenoid valve (22) reaches its final position.

### BACKGROUND INFORMATION

The present invention is directed to a method for operating a solenoid valve for quantity control, and a device for supplying fuel to an internal combustion engine with a solenoid valve for quantity control according to the general class of the independent claims.

The present invention further relates to a control device for carrying out a method for operating a solenoid valve for quantity control, and a computer program product for carrying out the method on a computer.

A method for operating a fuel supply device with a quantity control valve was previously made known in DE 199 13 477. The quantity control valve is open with no current; to close it, a constant voltage—the battery voltage—is applied, and the current increases in a characteristic manner. After the voltage is interrupted, the current decreases in a characteristic manner, and the valve opens shortly after the current has decreased.

A method for operating a solenoid valve for a brake cylinder was made known in DE 102 01 453. The disclosed solenoid valve is open with no current; to close it, it is controlled with a constant voltage. When a maximum inrush current is reached, the coil of the solenoid valve is controlled with a pulsed voltage; the current through the coil therefore drops to a minimum permissible holding current. To open the solenoid valve, the voltage applied to the solenoid valve is interrupted; the current decrease of the holding current takes place more quickly than when a maximum inrush current is applied.

In contrast, the inventive method with the features of the independent claim has the advantage that a first voltage is initially applied to a coil of the solenoid valve until a first point in time is reached, then a second voltage having a smaller value than that of the first voltage is applied. The switchover to the second voltage at the first point in time takes place before the solenoid valve reaches its final position. The particular advantage of this inventive method is that, with the first applied voltage, the coil current and, therefore, the magnetic force builds up rapidly, thereby enabling the solenoid valve to start moving sooner. By switching over to a second, lower voltage value, an unnecessary increase in coil current is prevented. The first point in time can lie before or after a certain force value at which the solenoid armature begins to move is reached. It is important that a reliable start-up of the solenoid armature is ensured by way of the inventive control. The inventive method can be used on valves that are open or closed with no current. By switching over to a second voltage with a value that is lower than that of the first voltage, the situation is avoided in which the coil current exceeds a maximum permissible current when control of the solenoid valve continues.

Advantageous embodiments and refinements of the inventive device are made possible by the measures listed in the subclaims.

It is particularly advantageous when the second voltage is at least so great that the motion of the solenoid valve is continued, thereby ensuring that the solenoid valve closes/opens reliably.

According to a further advantageous embodiment, the second voltage is advantageously selected such that the current through the coil and, therefore, the force acting on the solenoid valve, continues to rise. As a result, the reliability of the closing motion/opening motion is increased further.

According to a further advantageous embodiment, starting at a second point in time, a third voltage is applied to the coil of the solenoid valve that has a value that is less than that of the second voltage and does not allow the current to increase further as compared with the second voltage. This advantageously prevents the situation in which the coil current continues to increase and exceeds a maximum permissible current.

According to a further advantageous embodiment, starting at a third point in time, a fourth voltage is applied to the coil of the solenoid valve, the value of which is less than that of the third voltage, and a current sets in that is at least so great that a minimum holding force of the solenoid valve is ensured.

According to a further advantageous embodiment, the effective voltage of at least one of the voltages applied to the coil of the solenoid valve is influenced via pulse-width modulation. The advantage of this is that all voltages starting from a basic voltage can be adjusted solely via pulse-width modulation in accordance with the desired voltage level.

According to a further advantageous embodiment, a device for controlling a solenoid valve is provided, in particular a control device in a motor vehicle, the device controlling the solenoid valve such that a first voltage is initially applied to a coil of a solenoid valve until motion of the solenoid valve is triggered, then a second voltage is applied that has a value that is smaller than that of the first voltage.

According to a further advantageous embodiment, it is provided that the points in time at which the voltages are switched over, and the electrical voltage are stored in a program map as a function of operating variables, e.g., of the internal combustion engine, the high-pressure pump, etc.

According to a further advantageous embodiment, it is provided that the inventive method and procedure are stored as a computer program product with program code on a machine-readable storage device, and that the method is carried out according to the present invention when the program is run on a computer, arithmetic unit, control device, etc. Diskettes, memory components, Flash ROM, optical storage devices, hard drives, etc. can also be advantageously used as machine-readable storage devices.

### DRAWING

Further features, possible applications and advantages of the present invention result from the description of exemplary embodiments of the present invention, below, the exemplary embodiments being depicted in the drawing. All of the features that are described or depicted, either alone or in any combination, are the subject of the present invention, independent of their wording in the claims or their backward reference, and independent of their wording and/or depiction in the description and the drawing.

FIG. 1 is a schematic illustration of a device for supplying fuel to an internal combustion engine;

FIG. 2 is a schematic illustration of various functionality states of a high-pressure pump, with an associated time diagram;

FIG. 3 is a schematic illustration of the course over time of the displacement of the solenoid valve and the force acting on it after current is supplied to the solenoid valve;

FIG. 4 is a schematic illustration of the course over time of pressure in the high-pressure pump;

FIG. 5 is a schematic illustration of the course over time of voltage applied to the coil of the solenoid valve;

FIG. 6 is a schematic illustration of the course over time of the current flowing through the coil;

FIG. 7 is a schematic illustration of the course over time of current and voltage applied to the coil of the solenoid valve, for a certain control period.

For simplicity, the description is limited essentially to a normally open solenoid valve. The inventive method is not limited to this embodiment, however. It also applies to normally closed solenoid valves, in particular.

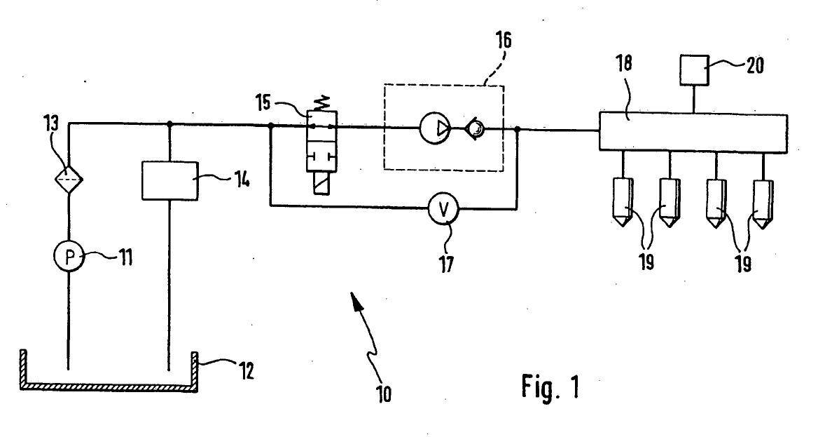

FIG. 1 shows a device 10 for supplying fuel to an internal combustion engine, as an example. Device 10 includes an electric fuel pump 11, with which fuel is pumped out of fuel tank 12 and is pumped further through a fuel filter 13. Fuel pump 11 is suitable for producing a low pressure. To control and/or regulate this low pressure, a low-pressure regulator 14 is provided that is connected with the outlet of fuel filter 13, and via which fuel can be returned to fuel tank 12. A series circuit composed of a quantity control valve 15 and a mechanical high-pressure pump 16 is also connected to the outlet of fuel filter 13. Outlet of high-pressure pump 16 is connected back to inlet of quantity control valve 15 via an overpressure relief valve 17. The outlet of high-pressure pump 16 is also connected with a pressure reservoir 18, to which several fuel injectors 19 are connected. Pressure reservoir 18 is often referred to as a rail or a common rail. A pressure sensor 20 is also connected to pressure reservoir 18. In the current example, the fuel supply device depicted in FIG. 1 serves to supply fuel injectors 19 of a four-cylinder internal combustion engine with an adequate amount of fuel and the necessary fuel pressure, thereby ensuring reliable fuel injection and operation of the internal combustion engine.

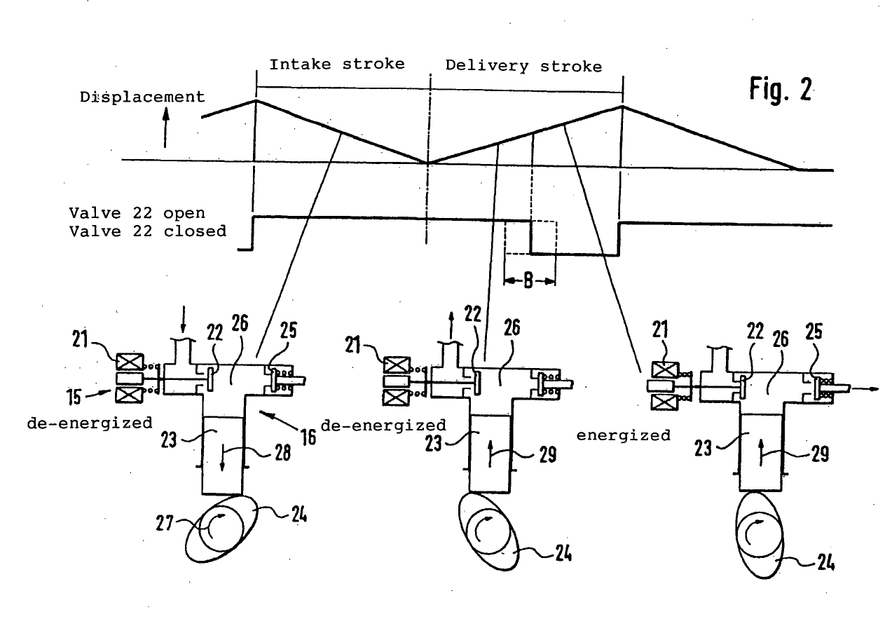

The mode of operation of quantity control valve 15 and high-pressure pump 16 are depicted separately in FIG. 2. Quantity control valve 15 is designed as a normally open solenoid valve and has a coil 21, via which solenoid valve 22 can be closed or opened by applying or interrupting an electric current or an electric voltage. High-pressure pump 16 has a piston 23 that is actuated by a cam 24 of the internal combustion engine. High-pressure pump 16 is also provided with a valve 25. A delivery chamber 26 of high-pressure pump 16 is provided between solenoid valve 22, piston 23 and valve 25.

Using solenoid valve 22, delivery chamber 26 can be cut off from a fuel supply and, therefore, the low pressure, via electric fuel pump 11. Using valve 25, delivery chamber 26 can be cut off from pressure reservoir 18 and, therefore the high pressure.

In the starting state, which is depicted on the left in FIG. 2, solenoid valve 22 is open and valve 25 is closed. Opened solenoid valve 22 corresponds to the de-energized state of coil 21. Valve 25 is held closed by the pressure of a spring or the like.

The intake stroke of high-pressure pump 16 is depicted on the left in FIG. 2. When cam 24 makes a rotary motion in the direction of arrow 27, piston 23 moves in the direction of arrow 28. Since solenoid valve 22 is open, fuel that has been pumped by electric fuel pump 11 flows into delivery chamber 26.

The delivery stroke of high-pressure pump 16 is depicted in the center illustration in FIG. 2. Coil 21 is still de-energized and solenoid valve 22 is therefore still open. Due to the rotary motions of cam 24, piston 23 moves in the direction of arrow 29. Since solenoid valve 22 is open, fuel is pumped out of delivery chamber 26 back in the direction toward electric fuel pump 11. This fuel then returns, via low-pressure regulator 14, to fuel tank 12.

The intake stroke of high-pressure pump 16 is also depicted at the right (in addition to the center) in FIG. 2. In contrast to the illustration in the center, coil 21 is now energized and solenoid valve 22 is therefore closed. The result is that pressure builds up in delivery chamber 26 as piston 23 continues its stroke. When the pressure reaches a level that matches the pressure in pressure reservoir 18, valve 25 opens, and the remaining quantity is pumped into the pressure reservoir.

The quantity of fuel pumped into pressure reservoir 18 depends on when solenoid valve 22 transitions into its closed state. The sooner solenoid valve 22 is closed, the greater the quantity of fuel is that is pumped via valve 25 into pressure reservoir 18. This is indicated in FIG. 2 by a range B labeled with an arrow.

As shown in illustration on the right in FIG. 2, as soon as piston 23 has reached its maximum displacement, no more fuel can be pumped by piston 23 via valve 25 into pressure reservoir 18. Valve 25 closes. Coil 21 is de-energized, so solenoid valve 22 reopens. Piston 23, which is now moving in the direction of arrow 28, as depicted on the left in FIG. 2, can now draw fuel from the electric fuel pump into delivery chamber 26 again.

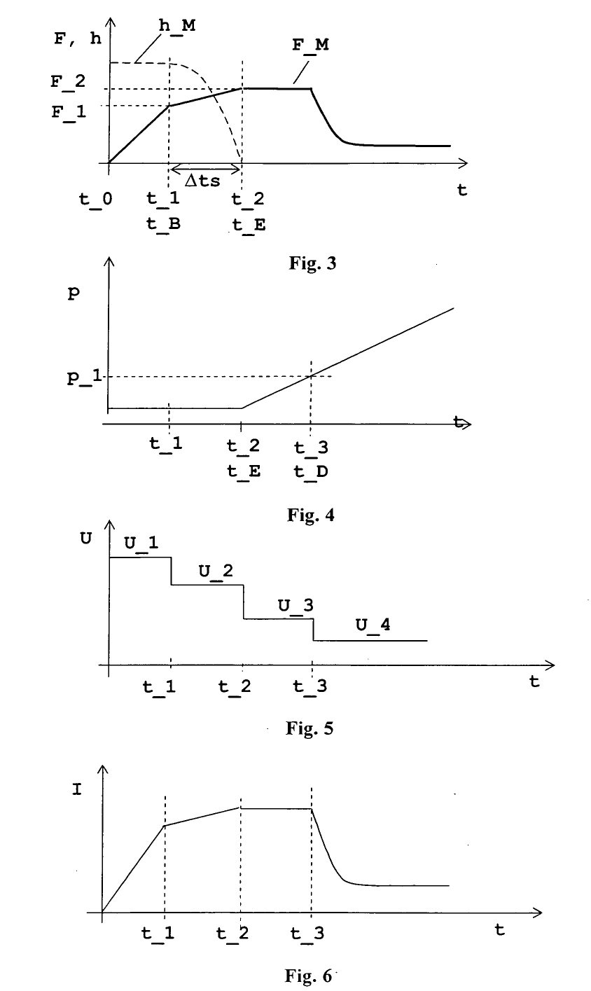

FIG. 3 shows a schematic illustration of the course over time of displacement h_M of solenoid valve 22 and force F_M acting on solenoid valve 22 when undervoltage is applied to coil 21 of solenoid valve 22. As soon as a first electric voltage U_1 is applied to coil 21 starting with control start t_0, a magnetic field starts to build up that acts on the armature of solenoid valve 22 with an electromagnetic force F_M. This electromagnetic force F_M opposes a spring force F_f of quantity control valve 15 under consideration. Solenoid valve 22 starts to move at a movement point in time t_B when electromagnetic force F_M overcomes spring force F_f. In the case illustrated in FIG. 3, a first point in time t_1 is set simultaneously with this movement point in time t_B, at which the first applied voltage U_1 is switched to the lower, second voltage U_2.

Second voltage U_2 is at least so high that the movement of the solenoid valve initiated by the application of first voltage U_1 continues. In the case shown, a second voltage U_2 is provided, in the case of which the coil current and, therefore, electromagnetic force F_M increases as the control time increases, but with a shallower slope than it does up to first point in time t_1. Solenoid valve 22 is in its final position at an end point in time t_E. With a normally open solenoid valve, solenoid valve 22 is completely closed up to end point in time t_E. With a normally closed solenoid valve, it is completely open. In the exemplary embodiment shown, a second point in time t_2 is set simultaneously with end point in time t_E. Starting at second point in time t_2, electromagnetic force F_M applied to the solenoid valve is held essentially constant and is reduced, e.g., to a minimum holding force starting at a third point in time t_3.

Movement point in time t_B, at which the solenoid valve starts moving under a certain type of control, and end point in time t_E are basically known for a particular solenoid valve. It can also be provided, however, to determine this movement point in time t_B using sensors or directly via the motion or indirectly via other variables.

Preferably, first point in time t_1, at which a switchover from first voltage U_1 to a second voltage U_2 takes place, is selected such that the length of time for which coil 21 of solenoid valve 22 is controlled with a first electrical voltage U_1 is at least so long that movement of solenoid valve 22 is initiated.

Depending on the embodiment, this first point in time t_1 can coincide with the actual movement point in time t_B of the solenoid valve. It can also be provided, however, to set first point in time t_1 before or after actual start-of-motion t_B. It is therefore feasible to select first point in time t_1 to be so early that, although the solenoid valve has not yet started moving at first point in time t_1, the duration of the control was so long that the energy applied to the coil is sufficient to set the solenoid valve in motion at a later point in time. In this case, although movement of the solenoid valve is initiated by applying a first voltage U_1 until a first point in time t_1, the actual movement of the solenoid valve takes place at a movement point in time t_B that lies after first point in time t_1.

After the switchover to second voltage U_2 at first point in time t_1, a waiting period Δts is provided, after which a switchover to a third voltage U_3 takes place after second point in time t_2. In FIG. 3, the length of waiting period Δts is designed such that second point in time t_2 coincides with solenoid valve 22 reaching its final position at end point in time t_E. When high-pressure pump 16 rotates at a slow rate of speed, it is sufficient to design waiting period Δts to be so generous that second point in time t_2 lies after end point in time t_E of solenoid valve 22, thereby enabling second point in time t_2 to be retained, unchanged, for a large number of operating conditions.

With regard for the operation of high-pressure pumps in a high speed range and the required short control times, it is appropriate, however, to set points in time t_1, 2, 3 at which the voltages are switched over to be as early as possible, to realize the shortest possible control times.

FIG. 4 is a schematic illustration of the course over time of the pressure in delivery chamber 26 of high-pressure pump 16 with a normally open solenoid valve 22. Before the solenoid valve reaches its final position, a constant low pressure prevails in delivery chamber 26 until end point in time t_E or second end point in time t_2, the constant low pressure being produced and adjusted by fuel pump 11 and low-pressure regulator 14. After solenoid valve 22 closes at end point in time t_E, piston 23—which is moving toward top dead center—compresses the volume in delivery chamber 26, which causes the fuel pressure to rise. At a pressure point in time t_D, the pressure in delivery chamber 26 reaches a holding pressure p_1. The force exerted by this holding pressure p_1 on solenoid valve 22 essentially corresponds to spring force F_f. The pressure force is basically sufficient to hold the solenoid valve in the closed state, even without it being controlled, i.e., it would be basically possible to interrupt the voltage applied to coil 21 of solenoid valve 22 at pressure point in time t_D. To ensure, among other things, a high level of operational reliability and/or defined operating states, it is provided to provide a third point in time t_3 at pressure point in time t_D, at which a switchover to a fourth voltage U_4 is carried out, and to reduce electromagnetic force F_M that is applied to a safety holding force.

The voltages applied to coil 21 of solenoid valve 21 at the various times are illustrated schematically in FIG. 5, and the corresponding coil currents are depicted in FIG. 6. As indicated in both figures, a first voltage U_1 is applied to coil 21 of solenoid valve 22 to close solenoid valve 22. As time continues, after a first, second and third point in time t_1, t_2, t_3, a second, third and fourth voltage U_2, U_3, U_4 are applied, respectively, the subsequent voltage being smaller in value than the particular preceding voltage. As shown in FIG. 6, the currents corresponding to the voltages therefore behave in a characteristic manner. When first voltage U_1 is applied, the current increases rapidly. When second voltage U_2 is applied at point in time t_1, the current increases with a shallower slope. Starting at point in time t_2, the current remains essentially constant, then drops off after third point in time t_3 in a characteristic manner to an essentially constant, lesser value.

As described, a first voltage U_1 is applied to coil 21 to close solenoid valve 22. The coil current increases according to the known relationship I=U/R (1−exp(−t*R/L). The exponential term can be disregarded in the first approximation for the periods of time under consideration in this example. The first current increase corresponds to di_1/dt (t=0)=U/L and is therefore essentially dependent on the voltage applied and the inductivity of the coil. With regard for short switching times, high applied voltages and a low inductivity of coil 21 are required.

As the duration of control of the coil increases, coil current I and electromagnetic force F_M acting on solenoid valve 22 increase; i.e., the more rapidly the current increases, the more quickly the applied force F_M increases, the sooner the closing motion starts, and the more quickly solenoid valve 22 closes.

As soon as solenoid valve 22 starts moving at first point in time t_1, a further, rapid current increase and/or force increase is no longer necessary. According to the present invention, it is provided to slow the current increase. Starting at first point in time t_1, coil 21 is supplied with a second voltage U_2, the value of which is smaller than that of first voltage U_1. The magnitude of second voltage U_2 is designed such that current I continues to increase. Second current increase di_2/dt, which corresponds to second voltage U_2, is smaller than first current increase di_1/dt, which corresponds to higher, first voltage U_1. The magnitude of second current increase di_2/dt or associated second voltage U_2 is preferably selected such that the maximum permissible coil current of solenoid valve 22 is not exceeded until a later, second and/or third point in time t_2, t_3.

As described previously, solenoid valve 22 is closed at second point in time t_2. A further increase in electromagnetic force F_M acting on solenoid valve 22 does not improve the reliable closure of the solenoid valve. According to the present invention, a further current increase or increase in electromagnetic force F_M is therefore not provided. For this purpose, the voltage applied to coil 21 is reduced further to third voltage U_3, which is designed such that coil current I essentially increases no further.

As time continues, pressure p in delivery chamber 26 reaches—at third point in time t_3—a pressure p_1, at which it can be assumed that solenoid valve 22 can be held closed essentially solely by the force of the pressure that has built up. According to the present invention, electromagnetic force F_M acting on solenoid valve 22 is reduced by further reducing the voltage, to a fourth voltage U_4. By applying fourth voltage U_4, corresponding coil current I drops off, in characteristic fashion, to an essentially constant holding current.

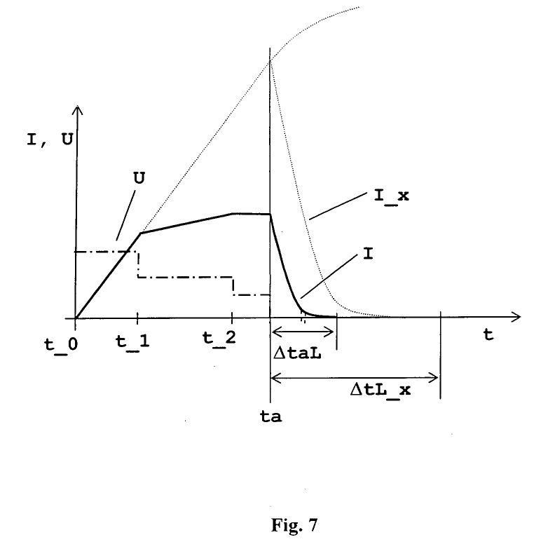

FIG. 7 shows, in a schematic illustration, as an example, a control of the inventive device with a control duration/time ta and the course over time of current and voltage applied to coil 21 of solenoid valve 22. The control of solenoid valve 22 starts at point in time t_0 and ends shortly after second point in time t_2, at point in time ta. Starting at point in time t_0, first voltage U_1 is applied, and it is reduced, as described, at first and second points in time t_1, t_2 to second and third voltage U_2, U_3, respectively. The course of current over time behaves accordingly, i.e., the current first increases rapidly, then it increases with a flat slope. Starting at second point in time t_2, it remains essentially constant. At the end of control period ta, applied third voltage U_3 is switched off, and the current drops off in a characteristic manner.

At the point at which a certain current value is fallen below, it is assumed, for simplicity, that coil 21 is without current, and essentially no electromagnetic force F_M is being applied to solenoid valve 22, so that solenoid valve 22 opens when the pressure in delivery chamber 26 falls accordingly. The relevant time for extinction of the magnetic field results essentially from the known relationship I=I_max*exp(−t*R/L). Extinction time ΔtL_1, which results at control period ta, is indicated accordingly in FIG. 7.

Starting at first point in time t_1, a higher course of current over time is indicated using a dotted line that would occur if a first voltage U_1 were retained, without reducing the voltage. If it is assumed in the present case that the higher course of the current over time has not yet destroyed the coil at switch-off time ta, it is obvious from FIG. 7 that extinction time ΔtL_x is clearly longer when current is higher than is extinction time ΔtaL that occurs with the lower current according to the present invention.

As a result of the inventive method it is possible to optimize solenoid valve 22 and, in particular, a quantity control valve, in terms of short control times, when the high-pressure pump runs at high speeds. It can be provided, for example, to rest intake valve loosely against magnet plunger, a spring pressing against intake valve/solenoid valve 22 via an additional device in delivery chamber 26. As a result, the plunger displacement can be designed to be much smaller which, in turn, allows the short switching/control times required for high speeds to be attained. A further measure is to use a low-resistance coil with a reduced number of windings, which results in a rapid current increase or a rapid increase in electromagnetic force.

In a further embodiment, it is provided to adjust at least one of the voltages U_1,2,3,4 applied to coil 21 of solenoid valve 22 using pulse-width modulation (PWM). By changing the pulse and pause times, it is therefore possible, e.g., starting at a first operating voltage, to adjust the effective voltage of the further voltages such that a course of current or force over time according to the present invention exists at the desired points in time. For example, the vehicle electrical supply voltage can be used as first voltage U_1, and all further voltages are reduced according to the present invention via appropriate pulse-width modulation.

During normal operation of the high-pressure pump, it is provided, as also shown in FIG. 2, to control quantity control valve 15 during the delivery stroke. In particular it should be ensured that quantity control valve 15 is open at the beginning of the intake stroke. The control of quantity control valve 15 typically ends between the second and third point in time t_2, t_3. Quantity control valve 15 is open again after the extinction time that follows the control time.

Control beyond third point in time t_3 typically occurs only at very low speeds, which occur, e.g., when the internal combustion engine is started. By switching over to a low holding current, the load on coil 21 of solenoid valve 22 is reduced, particularly at the start.

In a further embodiment, it is feasible to store the points in time and the necessary electrical voltages as a function of operating variables in a program map, so that an appropriate control of quantity control valve 15 can be taken from the program map under any operating condition, e.g., using an electronic control unit, a control element, or an arithmetic unit. Typical operating variables can be, e.g., engine speed nmot and, accordingly, speed n_hdp of high-pressure pump, the necessary delivery start or control point in time, the available battery/operating voltage U_Bat, U_Bet, operating temperature T_M of the solenoid valve, and other variables.

It can also be provided for the switchover between the various voltages to take place continually, rather than in steps.

According to a further embodiment it is provided to continue the current increase starting at first point in time t_1 until point in time t_3, whereby a maximum current is never exceeded.

According to a further embodiment, it is provided that, once solenoid valve 22 is closed at point in time t_2, and the pressure in delivery chamber 26 increases, electromagnetic force F_M, or current and voltage, is reduced continually to a minimum holding force, in contrast to the rising pressure.

According to a further preferred embodiment, it is provided, as already described with reference to FIGS. 3 through 7, to initially apply a high, first voltage U_1 to coil 21 of solenoid valve 22 and, as soon as the closing motion of the solenoid valve starts at a first point in time t_1, to apply a second, lower voltage U_2. Second voltage U_2 is selected such that the current does not continue to climb, but electromagnetic force F_M acting on solenoid valve 22 is adequate to continue the closing motion of solenoid valve 22.

According to a further preferred embodiment, it is provided to apply a high, first voltage U_1 to coil 21 of solenoid valve 22 and, before the closing motion of the solenoid valve starts at a first point in time t_1, to apply a second, lower voltage U_2. Second voltage U_2 is selected such that the further build-up of magnetic force of force F_M is adequate to reliably close solenoid valve 22.

In a possible exemplary embodiment, the second voltage is essentially equal to third voltage U_3, which, according to the present invention, is selected after solenoid valve 22 has closed completely, at point in time t_2. Using a method of this type, a switchover of voltages at second point in time t_2 can be advantageously eliminated.

In a further exemplary embodiment it is provided to select second voltage t_2 such that the value of current I that becomes established is greater than that of current I that flows with third voltage t_3.

In a further exemplary embodiment it is provided to control the solenoid valve with current, and to make the voltage to be selected at the particular points in time t_0, 1, 2, 3 4 dependent on a specified current increase.

Basically, the physical points in time, such as the movement point in time t_B, the end point in time t_E and the pressure point in time, can be determined, e.g., via direct or indirect measurement, or via modeling or emulations.

The switchover points in time, i.e., the first, second and third points in time t_1, 2, 3, and control start t_0 are determined with respect to the physical conditions and operating conditions, but the switchover times need not necessarily coincide with certain events, such as the physical points in time.

It is also feasible, in particular, to eliminate waiting period Δts, depending on the application, for instance, so that first point in time t_1 coincides with second point in time t_2 and, therefore, it is equal to third voltage U_3 after first voltage U_1 is applied. It can also be provided that waiting period Δts is designed such that second point in time t_2 coincides with third point in time t_3, and fourth voltage U_4 therefore follows immediately after second voltage U_2 is applied. All intermediate points in time can also be realized, of course.

The embodiments and exemplary embodiments are not limited to the sole example, of course. Instead, any combination of them defines the subject matter of the present invention.

What is claimed is:

1. A method for controlling a solenoid valve, particularly in a motor vehicle, in the case of which a first voltage (U_1) is applied to a coil (21) of the solenoid valve (22) until a first point in time t_1, then a second voltage (U_2) with a smaller value is applied,
wherein
the first point in time t_1 precedes the point in time at which the solenoid valve (22) reaches its final position.

2. The method as recited in claim 1,
wherein
the second voltage (U_2) is at least so great that the final position of the solenoid valve (22) is reached.

3. The method as recited in one of the preceding claims claim 1,
wherein
the current (I) continues to climb while the second voltage (U_2) is being applied.

4. The method as recited in at least one of the claim 1,
wherein,
starting at a point in time (t_2), a third voltage (U_3) is applied to the coil of the solenoid valve, the value of which is essentially equal to or less than that of the second voltage (U_2) and does not allow the current to increase further as compared with the second voltage (U_2).

5. The method as recited in at least one of the claim 1,
wherein,
starting at a third point in time (t_3), a fourth voltage (U_4) is applied to the coil of the solenoid valve, the value of which is essentially less than that of the third voltage (U_3), and a current flows that is at least so great that a minimum holding force of the fuel supply control valve is ensured.

6. The method as recited in claim 1,
wherein
the effective voltage of at least one of the voltages (U_1, U_2, U_3, U_4) applied to the coil of the solenoid valve is influenced via pulse-width modulation.

7. A device for controlling a solenoid valve, particularly in a motor vehicle, in the case of which a first voltage (U_1) is applied to a coil (21) of the solenoid valve (22) until a first point in time t_1, then a second voltage (U_2) with a smaller value is applied,
wherein
the first point in time t_1 precedes the point in time at which the solenoid valve (22) reaches its final position.

8. The device as recited in claim 7,
wherein
the points in time t_1, 2, 3, 4 and the electrical voltages U_1, 2, 3, 4 are stored in a program map as a function of operating variables.

9. A computer program product with program code that is stored on a machine-readable storage device for carrying out the method as recited in claim 1 when the program is run on a computer.
